(19) United States
(12) Patent Application Publication
(10) Pub. No.: US 2026/0084733 A1
(43) Pub. Date: Mar. 26, 2026

(54) CONDUITLESS CROSSING GATE WITH SWIVEL SUPPORT FOR CROSSING GATE MECHANISM

(71) Applicant: Siemens Mobility, Inc., New York, NY (US)

(72) Inventors: Richard C. Bohme, Louisville, KY (US); Zhenzhong Long, Louisville, KY (US)

(73) Assignee: Siemens Mobility, Inc., New York, NY (US)

(21) Appl. No.: 18/892,962

(22) Filed: Sep. 23, 2024

(51) Int. Cl. B61L 29/04; H02G 3/08; H02G 3/16

(52) U.S. Cl. CPC B61L 29/04; H02G 3/083; H02G 3/16

(57) ABSTRACT

A crossing gate including a junction box mounted to a foundation, the junction box housing and terminating electrical wiring, a crossing gate mechanism housing multiple electric and electronic components configured to operate a crossing gate arm coupled to the crossing gate mechanism, and a vertical mast supporting the crossing gate mechanism, wherein the electrical wiring between the junction box and the crossing gate mechanism runs through the vertical mast, wherein a support collar is arranged adjacent to the crossing gate mechanism, and wherein the support collar allows rotation of the crossing gate mechanism while keeping connection points of the electrical wiring in the crossing gate mechanism intact.

### TECHNICAL FIELD

Aspects of the present disclosure generally relate to highway crossing gates and crossing gate mechanisms, more particularly, to a conduitless crossing gate with swivel support for a crossing gate mechanism.

### BACKGROUND ART

A highway crossing, also referred to as level crossing or grade crossing, is an intersection where a railway line crosses a road or path. To ensure safety of grade crossings, crossing control systems including signal control equipment are installed at railway crossings. Signal control equipment includes for example a constant warning time device, also referred to as a grade crossing predictor (GCP) in the U.S. or a level crossing predictor in the U.K., which is an electronic device that is connected to rails of a railroad track and is configured to detect the presence of an approaching train and determine its speed and distance from a crossing, i.e., a location at which the tracks cross a road, sidewalk or other surface used by moving objects. The constant warning time device will use this information to generate a constant warning time signal for a crossing warning device.

A crossing warning device is a device that warns of the approach of a train at a crossing, examples of which include crossing gates with gate arms, crossing lights (such as the red flashing lights often found at highway grade crossings in conjunction with the crossing gate arms), and/or crossing bells or other audio alarm devices. Crossing gates utilize electrical and mechanical components to ensure that the crossing gates perform their intended functions correctly. For example, gate arms are lowered using a motor located in a crossing gate mechanism, herein also referred to as gate control mechanism. A crossing gate mechanism may be described as gate control box housing multiple electric and electronic components for operating and controlling the signal control equipment and warning devices, such as the crossing gates.

### SUMMARY

Briefly described, one or more embodiments of the present disclosure provide a crossing gate system and a crossing gate mechanism. More specifically, the present disclosure provides a crossing gate system without an external conduit and with swivel support for the crossing gate mechanism.

A first aspect of the present disclosure provides a crossing gate comprising a junction box mounted to a foundation, the junction box housing and terminating electrical wiring, a crossing gate mechanism housing multiple electric and electronic components configured to operate a crossing gate arm coupled to the crossing gate mechanism, and a vertical mast supporting the crossing gate mechanism, wherein the electrical wiring between the junction box and the crossing gate mechanism runs through the vertical mast, wherein a support collar is arranged adjacent to the crossing gate mechanism, and wherein the support collar allows rotation of the crossing gate mechanism while keeping connection points of the electrical wiring in the crossing gate mechanism intact.

A second aspect of the present disclosure provides a crossing gate mechanism comprising an enclosure housing multiple electric and electronic components including a control unit configured to operate the crossing gate mechanism and associated crossing gate arm, a cover for opening and closing the enclosure, wherein the enclosure comprises an opening in an underside of the enclosure, wherein the underside of the enclosure is configured to align with a support collar, and wherein electrical wiring is run from the support collar through the opening in an inside of the enclosure.

A third aspect of the present disclosure provides a support collar for a crossing gate mechanism, the support collar comprising a circular or semi-circular collar body, wherein the body is configured to fit around a vertical mast adjacent to a crossing gate mechanism arranged on the vertical mast, wherein the collar body comprises a first opening, a second opening and a hollow space for electrical wiring to run through the collar body, wherein the first opening is configured to align with an opening in a vertical mast, and wherein the second opening is configured to align with an opening in an underside of a crossing gate mechanism enclosure.

### BRIEF DESCRIPTION OF THE DRAWINGS

FIG. 1 illustrates a perspective view of a known highway crossing gate in accordance with the present disclosure.

FIG. 2 illustrates a perspective view of a highway crossing gate in accordance with an exemplary embodiment of the present disclosure.

FIG. 3 and FIG. 4 illustrate perspective views of a first embodiment of a support collar (swivel support) for a highway crossing gate in accordance with an exemplary embodiment of the present disclosure.

FIG. 5 and FIG. 6 illustrate perspective views of the first embodiment of the support collar (swivel support) mounted with a highway crossing gate mechanism in accordance with an exemplary embodiment of the present disclosure.

FIG. 7 illustrates a sectional view of the first embodiment of the support collar with the crossing gate mechanism mounted at the vertical mast in accordance with an exemplary embodiment of the present disclosure.

FIG. 8 illustrates a perspective bottom view of the gate mechanism with additional components for the first embodiment of the support collar in accordance with an exemplary embodiment of the present disclosure.

FIG. 9 and FIG. 10 illustrate perspective views of the first embodiment of the support collar including rotation of the gate mechanism in accordance with an exemplary embodiment of the present disclosure.

FIG. 11 and FIG. 12 illustrate perspective views of a second embodiment of a support collar (swivel support) for a highway crossing gate in accordance with an exemplary embodiment of the present disclosure.

FIG. 13 illustrates a sectional view of the second embodiment of a support collar (swivel support) for a highway crossing gate in accordance with an exemplary embodiment of the present disclosure.

### DETAILED DESCRIPTION

To facilitate an understanding of embodiments, principles, and features of the present disclosure, they are explained hereinafter with reference to implementation in illustrative embodiments. In particular, they are described in the context of conduitless highway crossing gates and with swivel support for crossing gate mechanism.

The components and materials described hereinafter as making up the various embodiments are intended to be illustrative and not restrictive. Many suitable components and materials that would perform the same or a similar function as the materials described herein are intended to be embraced within the scope of embodiments of the present disclosure.

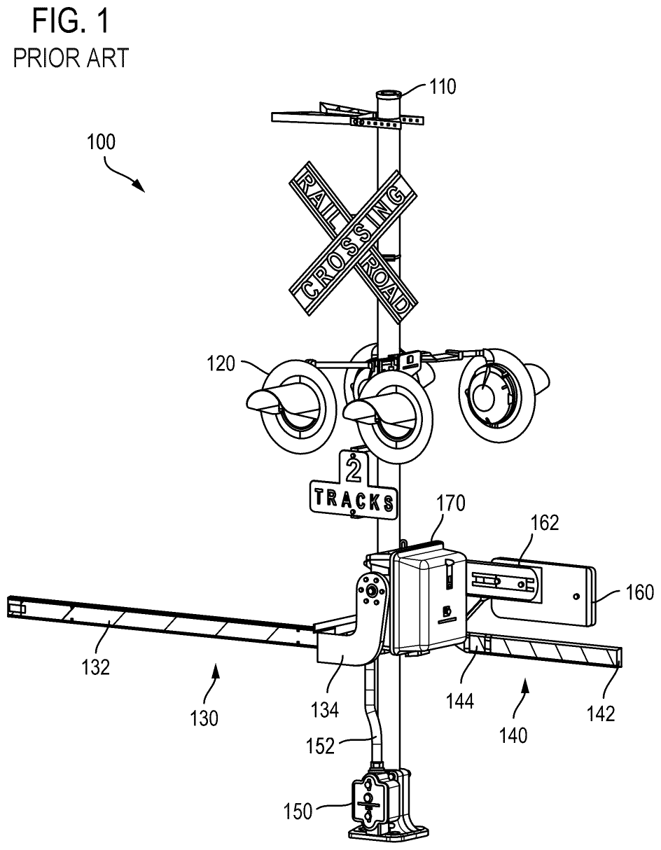

FIG. 1 illustrates a perspective view of a known highway crossing gate in accordance with the present disclosure.

At many grade crossings, at least one crossing gate 100 may be placed on either side of the railroad track to restrict roadway traffic in both directions. At some crossings, pedestrian paths or sidewalks may run parallel to the roadway. To restrict road and sidewalk traffic, the illustrated railroad crossing gate 100 includes a separate roadway gate 130 and pedestrian gate 140. The roadway gate 130 and pedestrian gate 140 may be raised and lowered, i.e. operated, by a gate mechanism 170. The crossing gate 100 is in a lowered or horizontal position.

The example railroad crossing gate 100 also includes a pole 110 and signal lights 120. The gate control mechanism 170 is attached to the pole 110 and is used to raise and lower the roadway and pedestrian gates 130, 140. When a train approaches the crossing, the railroad crossing gate 100 may provide a visual warning using the signal lights 120. The gate control mechanism 170 will lower the roadway gate 130 and the pedestrian gate 140 to respectively restrict traffic and pedestrians from crossing the track until the train has passed.

As shown in FIG. 1, the roadway gate 130 comprises a roadway gate support arm 134 that attaches a roadway gate arm 132 to the gate control mechanism 170. Similarly, the pedestrian gate 140 comprises a pedestrian gate support arm 144 connecting a pedestrian gate arm 142 to the gate control mechanism 170. When raised, the gates 130 and 140 are positioned so that they do not interfere with either roadway or pedestrian traffic. This position is often referred to as the vertical position. A counterweight 160 is connected to a counterweight support arm 162 connected to the gate control mechanism 170 to counterbalance the roadway gate arm 132. Although not shown, a long counterweight support arm could be provided in place of the short counterweight support arm 134.

Typically, the gates 130, 140 are lowered from the vertical position using an electric motor contained within the gate control mechanism 170. The electric motor drives gearing connected to shafts (not shown) connected to the roadway gate support arm 134 and pedestrian gate support arm 144. The support arms 134, 144 are usually driven part of the way down by the motor (e.g., somewhere between 70 and 45 degrees) and then gravity and momentum are allowed to bring the arms 132, 142 and the support arms 134, 144 to the horizontal position. In another example, the support arms 134, 144 are driven all the way down to the horizontal position by the electric motor of the gate control mechanism 170.

Further, the crossing gate 100 includes a junction box 150 mounted to a foundation (not shown). Electrical wiring, for example from/to the gate mechanism 170 and crossing bungalow (not shown), terminates in the junction box 150. The junction box 150 also connects to and holds the vertical mast (pole) 110. The mast 110 has a hole in the bottom for electrical wires to run up inside, typically for the flashing signal lights 120 and other warning signals (e.g. bell) that are at a higher level than the gate mechanism 170. The junction box 150 typically has a connection on the top for a conduit 152 to run and connect to a back side of the gate mechanism 170. Electrical wires for control, power, gate arm light and contact indication are run through the conduit 152.

Currently, the conduit 152 includes a metal lining for electromagnetic interference (EMI) shielding. Further, for maintenance and service purposes, the gate mechanism 170 with gate arms 132, 142 must be configured such that it can be rotated 90 degrees in horizontal direction while on the mast 110. Rotating the gate mechanism 170 including associated components 90 degrees for some maintenance activities keeps the railway works out of the road providing additional worker safety. Currently, with the conduit 152 in place, it is very hard to rotate the gate mechanism 170 with gate arms 132, 142. Further, in some cases the conduit 152 is not even long enough to allow rotation of the gate mechanism 170.

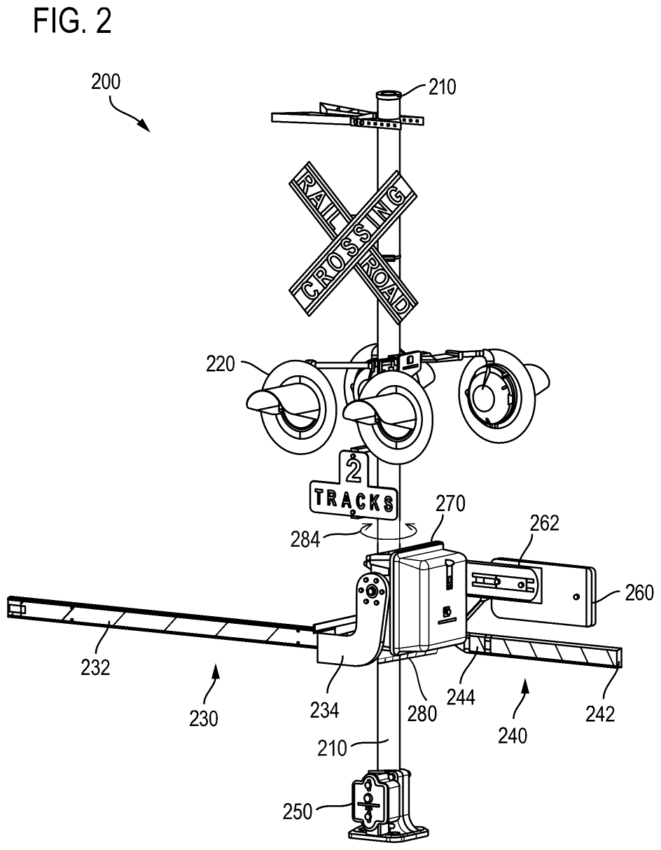

FIG. 2 illustrates a perspective view of a conduitless highway crossing gate in accordance with an exemplary embodiment of the present disclosure.

As noted above in connection with FIG. 1, currently, certain electrical wires from the junction box 150 to the crossing gate mechanism 170 and other components run through an external conduit, e.g. conduit 152. For maintenance/service purposes, the gate mechanism 170 with gate arms 132, 142 must be configured such that it can rotate 90° (ninety degrees) in horizontal direction while on the mast 110, so that the gate arms can be moved away from a highway/road and are basically parallel to the highway/road. With the conduit 152 in place, it is very hard to rotate the gate mechanism 170 with gate arms 132, 142. Further, in some cases, the conduit 152 is not even long enough to allow rotation of the gate mechanism 170.

In accordance with an exemplary embodiment of the present disclosure and with reference to FIG. 2, crossing gate 200 is designed as a conduitless crossing gate 200 with swivel support for crossing gate mechanism 270. Conduitless means without conduit, i.e. the crossing gate 200 does not comprise an external conduit for electrical wiring from junction box 250 to gate mechanism 270.

The crossing gate 200 comprises junction box 250 mounted to a foundation (not shown), the junction box 250 housing and terminating electrical wiring. The crossing gate 200 further comprises crossing gate mechanism 270 housing multiple electric and electronic components configured to operate crossing gate arms 232, 242 (and other components) coupled to the crossing gate mechanism 270, and vertical mast (post) 210 supporting the crossing gate mechanism 270. Electrical wiring, for example from/to the gate mechanism 270 and a crossing bungalow (not shown), terminates in the junction box 250. The junction box 250 also connects to and holds the vertical mast 210.

The electrical wiring from and/or to the junction box 250 runs through the vertical mast 210. Specifically, all necessary wiring runs through and inside the vertical mast 210 from the junction box 250 for example to the gate mechanism 270 and other devices. This means that any external conduit, as for example conduit 152 as shown in FIG. 1, is eliminated as there is no need for a conduit. Thus, the mast 210 comprises a hole/opening in the bottom to receive the electrical wiring from/to the junction box 250 and to run up inside the mast 210. The electrical wiring is for operating warning signals, for example flashing signal lights 220 and other warning signals (e.g. bell) as well as the gate mechanism 270 including control, power, gate arm light and contact indication.

Further, the crossing gate 200 comprises a support collar 280, herein also referred to as swivel support, that allows rotation of the crossing gate mechanism 270 while keeping connection points of the electrical wiring intact (especially in the gate mechanism 270) and the electrical wiring protected and safe. The support collar 280 is designed to allow rotation of the crossing gate mechanism 270 in horizontal direction around the vertical mast 210, as indicated by arrow 284.

The described crossing gate 200 eliminates the need for an external conduit from junction box 250 to gate mechanism 270 while protecting the electrical wiring, such as control wires, power wires etc. in metal parts, adding temper proof and vandal resistant EMI (electromagnetic interference) shielding, and allowing the assembly (gate mechanism 270 and gate arms 232, 242) to be rotated essentially 90° (ninety degrees) for service/maintenance activities. When rotated, the gate arms 232, 242 are essentially parallel to the respective highway/road, to not disturb traffic while performing maintenance or service on the crossing gate 200. Additionally, existing flexible conduits degrade over time due to sunlight and weather conditions.

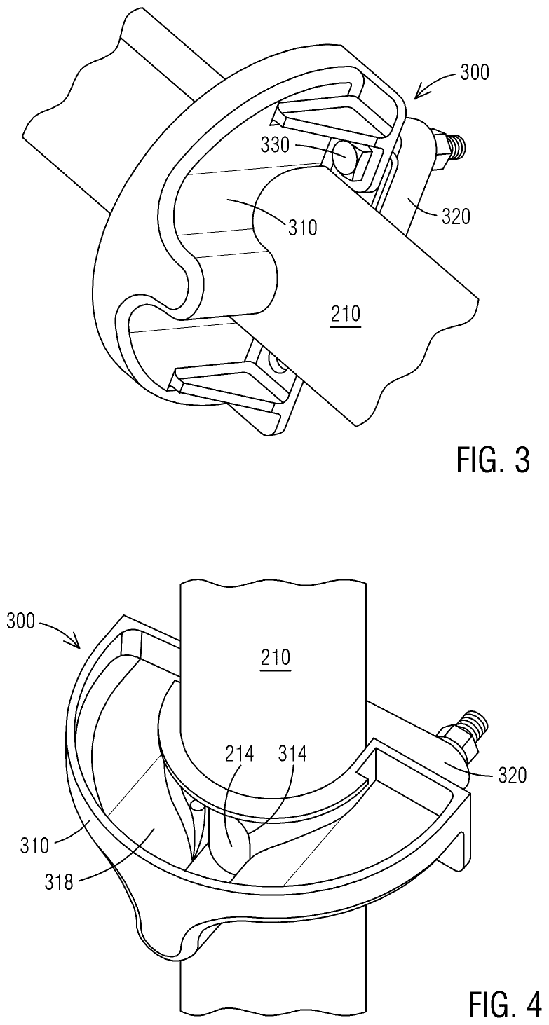

FIG. 3 and FIG. 4 illustrate perspective views of a first embodiment of a support collar (swivel support) 300 for a highway crossing gate in accordance with an exemplary embodiment of the present disclosure. The support collar 280, schematically shown in FIG. 2, may be embodied as support collar 300 as shown in FIG. 3 to FIG. 10.

The support collar 300, also referred to as swivel support, is basically an intermediate component between the vertical mast 210 and the gate mechanism 270 that facilitates housing and routing of electrical wiring from the vertical mast 210 into the gate mechanism 270. The electrical wiring runs from the junction box 250 (FIG. 2) to the support collar 300 and from the support collar 300 into the gate mechanism 270.

The support collar 300 comprises two (2) main components. A first component 310 comprises essentially a semi-circular shape, with a radius essentially corresponding to, but slightly greater than a radius of the vertical mast 210, so that the first component 310 is a close-fitting component around the mast 210. A second component 320 is for mounting and securing the first component 310 at the mast 210. The second component 320 is detachably connected at a rear side of the semi-circular shape of the first component 310 via bolts or screws 330.

The support collar 300 is designed to provide electromagnetic interference (EMI) shielding. For example, the support collar 300 comprises a metal and can be for example a cast aluminum component. Other materials for the support collar can be other types of metal, such as stainless steel. In another example, the support collar 300 may comprise durable plastic, for example polycarbonate (PC). In this case, the durable plastic is designed to provide EMI shielding, for example comprises a metallic lining or is interspersed with metallic particles. Both first and second components 310, 320 can be made from the same material or each component 310, 320 can comprise different materials.

The vertical mast 210 comprises a first opening 214 that is aligned with a second opening 314 in the first component 310 for routing the electrical wiring from the vertical mast 210 in the support collar 300, or vice versa. Further, the first component 310 comprises a third opening 318 that is aligned with a fourth opening in an underside of the crossing gate mechanism (see FIG. 6) for routing the electrical wiring from the support collar 300 in the gate mechanism for termination.

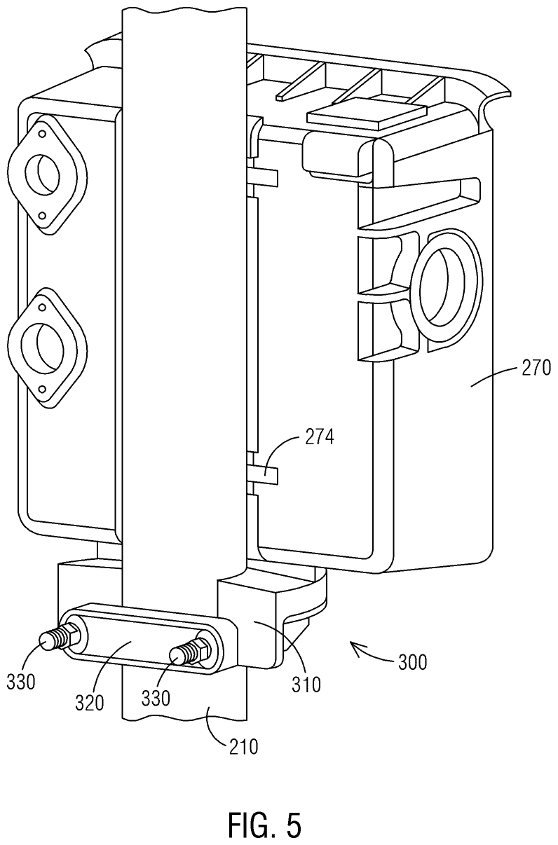

FIG. 5 and FIG. 6 illustrate perspective views of the first embodiment of the support collar 300 mounted with highway crossing gate mechanism 270 in accordance with an exemplary embodiment of the present disclosure.

FIG. 5 illustrates a perspective rear view of the support collar 300 when assembled and installed with the gate mechanism 270. The support collar 300 is arranged adjacent to the gate mechanism 270, specifically below at an underside of the gate mechanism 270. The rear view shows that the second component 320 holds and fastens the first component 310 to the vertical mast 210 via bolts 330. Further, the gate mechanism 270, specifically a housing/enclosure of the gate mechanism 270, is positioned and secured to the mast 210 via openings in the mast and a horizontal pin/bolt 274. The second component 320 of the support collar 300 carries the first component 310 of the support collar as well as the gate mechanism 270.

FIG. 6 illustrates a perspective front view of the support collar 300, together with the gate mechanism 270. A front side of the gate mechanism 270 is open or removed. This way, the fourth opening 278 in an underside of the gate mechanism 270 is visible. The opening is for routing the electrical wiring from the support collar 300, specifically the first component 310, in the gate mechanism 270 for termination. Further, the gate mechanism 270 comprises a curved rear side 282 that aligns and conforms with the shape of the post 210.

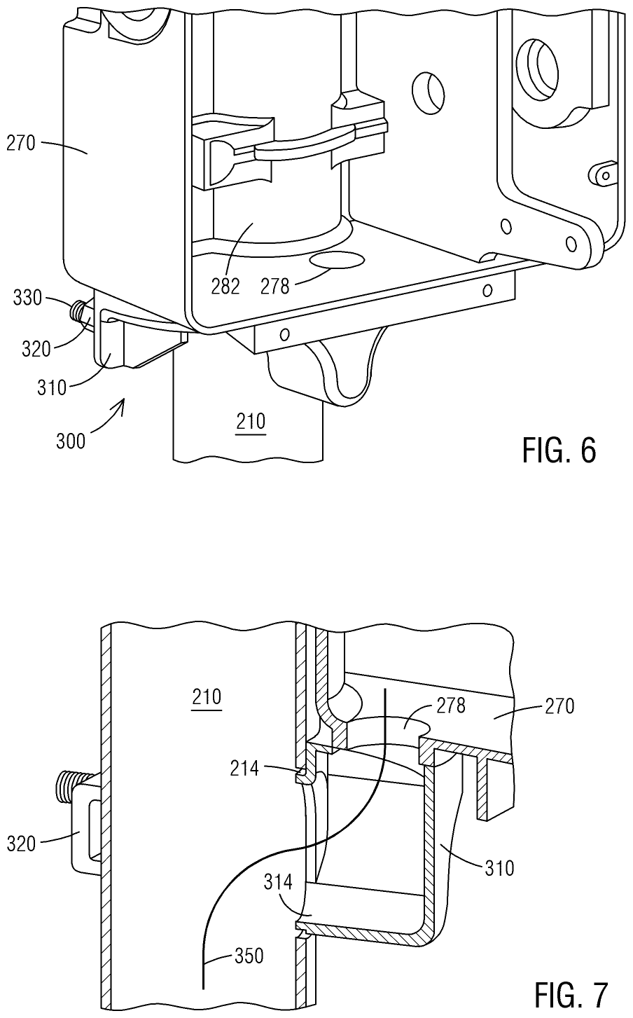

FIG. 7 illustrates a sectional view of the first embodiment of the support collar 300 with the crossing gate mechanism 270 mounted at the vertical mast 210 in accordance with an exemplary embodiment of the present disclosure.

Shown schematically is electrical wiring 350 which runs inside of the mast 210, entering the gate mechanism 270 via hole 214 in the mast 210, hole 314 in the first component 310 of the support collar 300, and hole 278 in an underside of the gate mechanism the gate mechanism 270. The electrical wiring 350 is terminated in the gate mechanism 270 and utilized for example for control, power, gate arm light and contact indication of the gate mechanism 270.

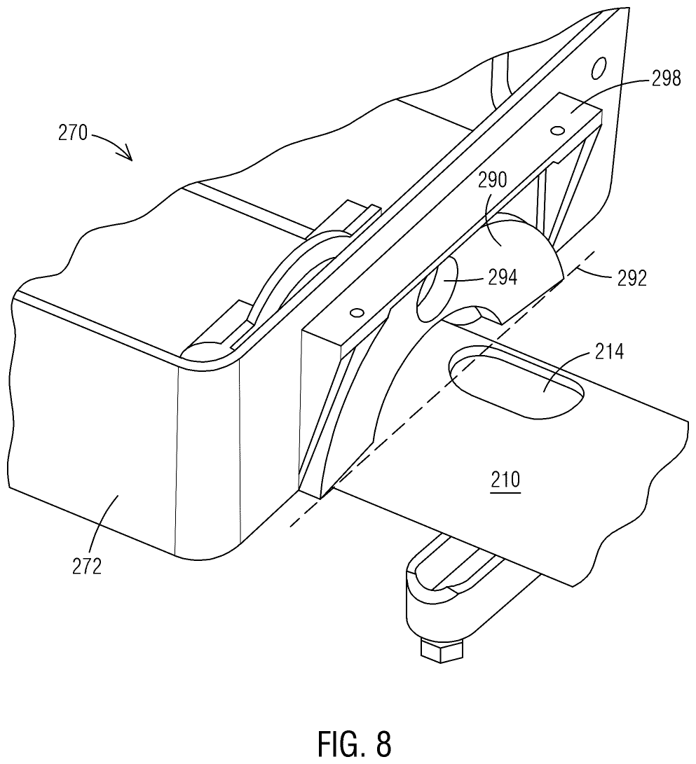

FIG. 8 illustrates a perspective bottom view of the gate mechanism 270 with additional components for the first embodiment of the support collar 300 in accordance with an exemplary embodiment of the present disclosure.

The housing/enclosure 272 of the gate mechanism 270 comprises a transition element 290, which can be a cast-in feature 290, on an underside outside surface that is a semi-circle with a draft angle. The draft angle is indicated/visualized by broken line 292, and can be between 1° and 5°, for example 4°, applied to the feature 290. The transition element 290 creates a large contact area for the support collar 300, specifically the first component 310 of the support collar 300, for support, and also acts as a bearing area allowing the transition element 290 to swivel about the mast 210. For rotation/swiveling, certain housing hardware of the gate mechanism 270 must be slightly loosened. The transition element 290 further comprises hole 294 which corresponds to hole 278 in the underside of the gate mechanism 270 (see FIG. 7) for routing the electrical wiring. Further, the housing 272 of the gate mechanism 270 comprises a cover feature 298, which is optional, configured to cover and protect a transition area between support collar 300 and gate mechanism 270.

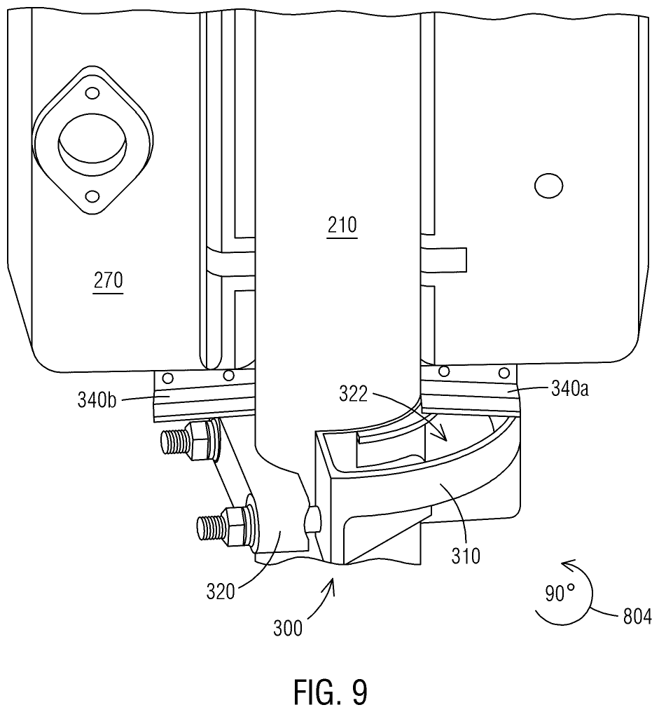

FIG. 9 and FIG. 10 illustrate perspective views of the first embodiment of the support collar 300 including rotation of the gate mechanism 270 in accordance with an exemplary embodiment of the present disclosure.

In these views, the gate mechanism 270 has been rotated 90° in horizontal direction around the vertical mast 210, as indicated by arrow 804. The support collar 300 with components 310, 320 does not rotate when the gate mechanism 270 is turned but stays in place at the mast 210. FIG. 9 illustrates that when the gate mechanism 270 is rotated, a top section 322 of the support collar 300 is open and exposed.

Further, additional cover elements 340a, 340b may be arranged on both end sides of the semi-circular transition element 290 of the gate mechanism 270. The cover elements 340a, 340b can be bolted or screwed to the element 290 and cover a top portion of the support collar 300 when the gate mechanism 270 is in place and not rotated. FIG. 5 illustrates both cover elements 340a, 340b in place and covering the top portion of the element 310 of the support collar 300. When the gate mechanism 270 is turned/rotated, one of the cover elements, specifically cover element 340b, protrudes the support collar 300 and is clearly visible, as shown in FIG. 10.

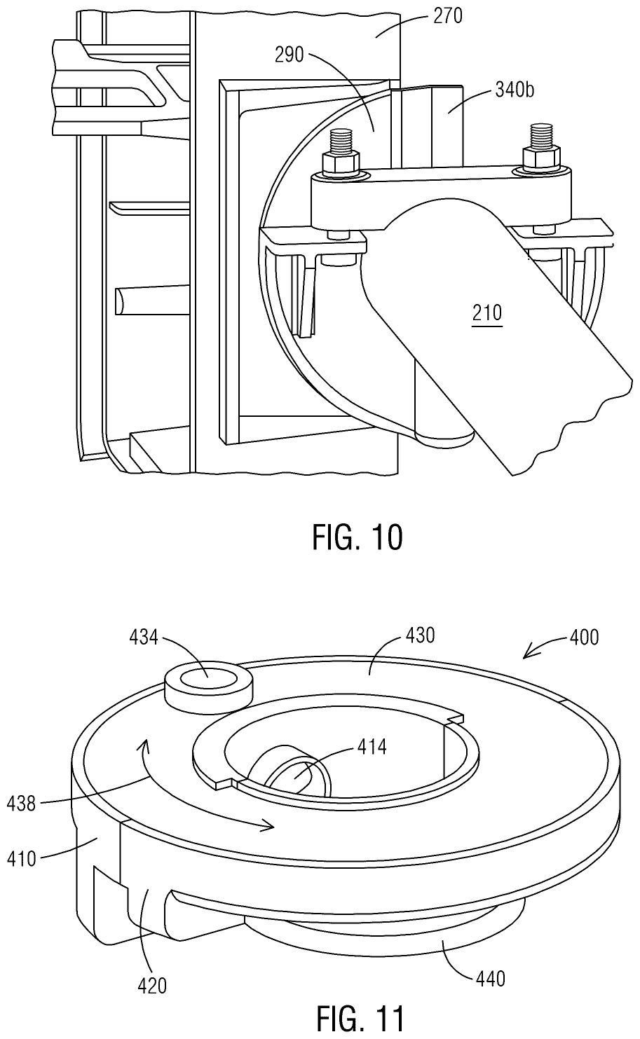

FIG. 11 and FIG. 12 illustrate perspective views of a second embodiment of a support collar (swivel support) 400 for a highway crossing gate in accordance with an exemplary embodiment of the present disclosure. The support collar 280 schematically shown in FIG. 2 may be embodied as support collar 400 as shown in FIG. 11 to FIG. 13.

The support collar 400 comprises another configuration compared to the support collar 300 described before but comprises similar characteristics and functionalities. The support collar 400 facilitates housing and routing of electrical wiring from the vertical mast 210 into (or out of) the gate mechanism 270. With reference to FIG. 2, the electrical wiring runs from the junction box 250 to the support collar 400 and from the support collar 400 into the gate mechanism 270 (or vice versa).

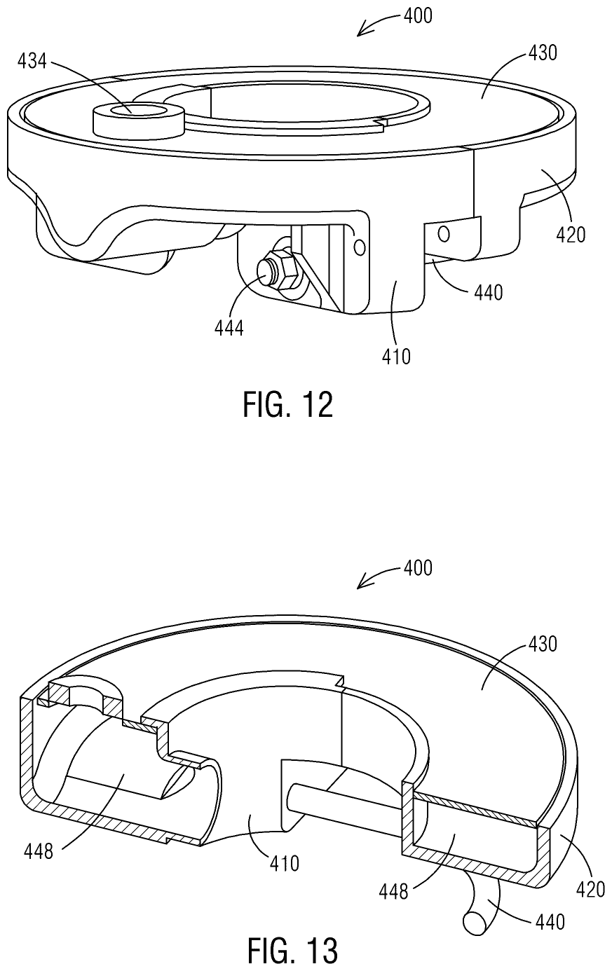

The support collar 400 comprises multiple components that, when assembled and arranged at the vertical mast 210, provide a close-fitting collar around the mast 210 adjacent to the gate mechanism 270. The collar 400 is a circular/ring-shaped component and comprises two (2) essentially semi-circular shaped sub-components 410, 420. The sub-components 410, 420 comprise an inner space or hollow for receiving the electrical wiring. Further, the support collar 400 comprises a circular lid 430 that covers the components 410, 420, specifically the hollow (see also FIG. 13) at a top side which faces the underside of the gate mechanism 270. One of the sub-components 410, 420, in our example the component 410, and the lid 430 each comprise a hole or opening 414, 434, respectively, for receiving and running the electrical wiring to/from the gate mechanism 270. The holes 414, 434 are aligned with each other, and are further aligned with the hole 278 in the underside of the gate mechanism 270 (see FIG. 6).

The opening 434 in the lid 430 is designed as protruding or projecting, so that the opening 434 can be inserted into the hole 278 of the gate mechanism 270 to form a connection or coupling between the lid 430 and the housing of the gate mechanism 270. The lid 430 is moveably secured by the components 410, 420. Thus, when the gate mechanism 270 is being rotated, the lid 430 moves together in a circular motion with the gate mechanism 270, indicated by arrow 438, whereas the sub-components 410, 420 do not rotate with the gate mechanism 270.

The support collar 400 further comprises a clamping mechanism 440 for clamping the support collar 400 to the mast 210. The clamping mechanism 440 is connected to one of the sub-components 410, 420. In our example, the clamping mechanism 440 is connected to the component 410 via a bolted connection 444. For example, ends of the clamping mechanism 440 can comprise a (screw) thread, wherein the threaded ends are inserted into corresponding holes in the component 410 and then fastened (around the mast 210) via nuts.

The support collar 400 comprises a metal and can be for example a cast aluminum component. Other materials for the support collar can be other types of metal, such as stainless steel, or durable plastic, for example polycarbonate (PC). The components 410, 420, 430 can be made from the same material or each component 410, 420, 430 can comprise different materials.

FIG. 13 illustrates a sectional view of the second embodiment of the support collar (swivel support) 400 for a highway crossing gate in accordance with an exemplary embodiment of the present disclosure.

The sectional view illustrates that the sub-components 410, 420 comprise an inner space or hollow 448 for receiving the electrical wiring. Assembling and installing of the support collar 400 may be as follows: assemble/insert lid 430 in sub-component 410, place sub-component 410 with lid 430 around vertical mast 210 and move projecting hole 434 into opening 278 in underside of gate mechanism 270, place and fasten sub-component 420 to sub-component 410, position clamping mechanism 440 and put ends of clamping mechanism 440 into holes of sub-component 410, and fasten clamping mechanism 440 secure and tight around vertical mast 210. The described embodiments of the support collar 300, 400 provide swivel support for the gate mechanism 270 while eliminating the need for an external conduit. All electrical wiring is run through the vertical mast 210. Thus, the electrical wiring, such as control wires, power wires etc. are protected in metal parts (mast 210). Further, temper proof and vandal resistant EMI (electromagnetic interference) shielding is provided. Furthermore, the support collars 300, 400 allow the assembly (gate mechanism 270 and gate arms 232, 242) to be rotated essentially 90° (ninety degrees) for service/maintenance activities, wherein the electrical wiring and connection/termination points of the wiring in the gate mechanism 270 are kept intact and properly connected. Additionally, existing flexible conduits degrade over time due to sunlight and weather conditions and thus needed to be replaced over time, which is not necessary any longer.

1. A crossing gate comprising:
a junction box mounted to a foundation, the junction box housing and terminating electrical wiring,
a crossing gate mechanism housing multiple electric and electronic components configured to operate a crossing gate arm coupled to the crossing gate mechanism, and
a vertical mast supporting the crossing gate mechanism,
wherein the electrical wiring between the junction box and the crossing gate mechanism runs through the vertical mast,
wherein a support collar is arranged adjacent to the crossing gate mechanism, and
wherein the support collar allows rotation of the crossing gate mechanism while keeping connection points of the electrical wiring in the crossing gate mechanism intact.

2. The crossing gate of claim 1,
wherein the electrical wiring is arranged in the vertical mast and in the support collar.

3. The crossing gate system of claim 1,
wherein the support collar allows rotation of the crossing gate mechanism in horizontal direction around the vertical mast.

4. The crossing gate of claim 1,
wherein the support collar comprises multiple sub-components that allow assembling the support collar around the vertical mast.

5. The crossing gate of claim 4,
wherein the support collar comprises a first component and a second component,
wherein the first component comprises an essentially semi-circular shape to fit around the vertical mast, and
wherein the second component is configured to hold and fasten the first component to the vertical mast.

6. The crossing gate of claim 4,
wherein the support collar comprises a first component and a second component,
wherein the first component and the second component comprise essentially semi-circular shapes to fit around the mast, and
wherein the support collar is secured and fastened to the vertical mast by a clamping mechanism.

7. The crossing gate of claim 1,
wherein the vertical mast comprises a first opening that is aligned with a second opening in the support collar for routing the electrical wiring from the vertical mast in the support collar.

8. The crossing gate of claim 7,
wherein the support collar comprises a third opening that is aligned with a fourth opening in an underside of the crossing gate mechanism for routing the electrical wiring from the support collar in the crossing gate mechanism.

9. The crossing gate of claim 1,
wherein the support collar and the crossing gate mechanism are adjacent to each other without exposing the electrical wiring.

10. A crossing gate mechanism comprising:
an enclosure housing multiple electric and electronic components including a control unit configured to operate the crossing gate mechanism and associated crossing gate arm,
a cover for opening and closing the enclosure,
wherein the enclosure comprises an opening in an underside of the enclosure,
wherein the underside of the enclosure is configured to align with a support collar, and
wherein electrical wiring is run from the support collar through the opening in an inside of the enclosure.

11. The crossing gate mechanism of claim 10,
a transition element arranged at an outside surface of the underside of the enclosure, the transition element matching at least partially a shape of the support collar,
wherein the transition element comprises a hole that is aligned with the opening in the underside of the enclosure, and
wherein the transition element comprises a draft angle that matches a draft of the support collar.

12. The crossing gate mechanism of claim 11,
wherein the enclosure is a cast metal component incorporating the transition element as a cast-in feature.

13. The crossing gate mechanism of claim 11, further comprising:
cover elements arranged on both end sides of the transition element 290 configured to cover a top portion of the support collar.

14. A support collar for a crossing gate mechanism, the support collar comprising:
a circular or semi-circular collar body,
wherein the body is configured to fit around a vertical mast and adjacent to a crossing gate mechanism arranged on the vertical mast,
wherein the collar body comprises a first opening, a second opening and a hollow space for electrical wiring to run through the collar body,
wherein the first opening is configured to align with an opening in a vertical mast, and
wherein the second opening is configured to align with an opening in an underside of a crossing gate mechanism enclosure.

15. The support collar for a crossing gate mechanism of claim 14,
wherein the electrical wiring is terminated in the crossing gate mechanism at connection points, and
wherein the support collar body allows rotation of the crossing gate mechanism while keeping connection points of the electrical wiring in the crossing gate mechanism intact.

16. The support collar for a crossing gate mechanism of claim 14,
wherein the support collar comprises a first component and a second component,
wherein the first component comprises an essentially semi-circular shape to fit around the vertical mast, and
wherein the second component is configured to hold and fasten the first component to the vertical mast via a bolted connection.

17. The support collar for a crossing gate mechanism of claim 14,
wherein the collar body comprises a first component and a second component,
wherein the first component and the second component comprise an essentially semi-circular shape to fit around the vertical mast.

18. The support collar for a crossing gate mechanism of claim 17, further comprising:
a clamping mechanism for fixing and securing the collar body to the vertical mast.

19. The support collar for a crossing gate mechanism of claim 16, further comprising:
a lid at a top side of the collar body, wherein the lid comprises the second opening for the electrical wiring,
wherein the second opening in the top lid is configured to couple to the opening in the underside of the crossing gate mechanism enclosure, and
when the crossing gate mechanism is rotated, the lid is configured to rotate with the crossing gate mechanism.
